(19) United States
(12) Patent Application Publication
(10) Pub. No.: US 2009/0150198 A1
(43) Pub. Date: Jun. 11, 2009

(54) ESTIMATING TV AD IMPRESSIONS

(76) Inventors: Yaroslav Volovich, Cambridge (GB); Geoffrey R. Smith, Mountain View, CA (US); Daniel J. Zigmond, Menlo Park, CA (US); Xiaohu Zhang, Mountain View, CA (US); Ajoy Bhambani, San Francisco, CA (US); Iain Merrick, London (GB)

Correspondence Address: FISH & RICHARDSON P.C., PO BOX 1022, MINNEAPOLIS, MN, 55440-1022, US

(21) Appl. No.: 12/055,906

(22) Filed: Mar. 26, 2008

Related U.S. Application Data
(60) Provisional application No. 61/012,634, filed on Dec. 10, 2007.

(51) Int. Cl. G06Q 10/00

(52) U.S. Cl. 705/7

(57) ABSTRACT

The subject matter of this specification can be embodied in, among other things, a method that includes receiving cluster information comprising categories and total numbers of media receivers (e.g. television (TV) viewers) associated with the categories and receiving sample data comprising numbers of advertisements (ads) displayed to sampled receivers (e.g., TV viewers) that are classified within the categories. The method also includes calculating probabilities for numbers of ads displayed to the total numbers of receivers associated with the categories, wherein the calculation is based on the cluster information and the sample data, merging the calculated probabilities associated with two or more of the categories, and outputting an estimated number of ads displayed based on the merged probabilities.

### CROSS-REFERENCE TO RELATED APPLICATIONS

This application claims priority to U.S. Application Ser. No. 61/012,634, filed on Dec. 10, 2007, and entitled “Estimating TV Ad Impressions,” the contents of which are hereby incorporated in its entirety by reference.

### TECHNICAL FIELD

This instant specification relates to information presentation.

### BACKGROUND

An advertiser, such as a business entity, can purchase airtime during, for example, a television broadcast to air television advertisements (“ads”). Example television advertisements include commercials that are aired during a program break, transparent overlays that are aired during a program, and text banners that are aired during a program.

The cost of the airtime purchased by the advertiser varies according to both the amount of time purchased and other parameters such as the audience size and audience composition expected to be watching during the purchased airtime or closely related to the purchased airtime. The audience size and audience composition, for example, can be measured by a ratings system. Data for television ratings can, for example, be collected by viewer surveys in which viewers provide a diary of viewing habits; or by set meters that automatically collect viewing habit data and transmit the data over a wired or wireless connection, e.g., a phone line or cable line; or by digital video recorder service logs, for example. Such rating systems, however, may be inaccurate for niche programming, and typically provide only an estimate of the actual audience numbers and audience composition.

Based on the ratings estimate, airtime is offered to advertisers for a fee. Typically the advertiser must purchase the airtime well in advance of the airtime. Additionally, the advertiser and/or the media provider may not realize the true value of the airtime purchased if the ratings estimate is inaccurate, or if the commercial that is aired is not relevant in the context of the program and/or audience.

### SUMMARY

In general, this document describes estimating the number of times an ad is displayed to viewers (e.g., television (TV) viewers).

In a first general aspect, a computer-implemented method is described. The method includes receiving cluster information comprising categories and total numbers of media receivers (e.g., television (TV) viewers) associated with the categories and receiving sample data comprising numbers of advertisements (ads) displayed to sampled receivers (e.g., TV viewers) that are classified within the categories. The method also includes calculating probabilities for numbers of ads displayed to the total numbers of receivers associated with the categories, wherein the calculation is based on the cluster information and the sample data, merging the calculated probabilities associated with two or more of the categories, and outputting an estimated number of ads displayed based on the merged probabilities.

In a second general aspect, a computer-implemented method is described that includes receiving, from a sample of television (TV) viewers, measurement data comprising information associated with one or more TV advertisements (ads) displayed to the TV viewers. The method also includes associating the sample of TV viewers with one or more clusters. Each cluster has geographic attributes and a total number of TV viewers within the cluster. The method includes determining multiple ad viewing estimates for a number of times an ad was viewed by the total number of TV viewers of the cluster. The ad viewing estimates are associated with probabilities of occurrence. Additionally, the method includes merging the probabilities associated with two or more clusters and outputting an estimated number of ads displayed for the one or more clusters based on the merged probabilities.

In another general aspect, a system is described that includes an interface to receive measurement data comprising numbers of advertisements (ads) displayed to sampled television (TV) viewers and cluster information comprising groupings defined by commonly shared attributes of TV viewers and a total number of TV viewers associated within each grouping. The system also includes means for calculating probabilities for a number of ads displayed to the total number of TV viewers for each cluster. The calculation is based on the cluster information and the measurement data. The system includes means for merging the calculated probabilities associated with the clusters and outputting an estimated number of ads displayed for the one or more clusters based on the merged probabilities.

The details of one or more embodiments feature are set forth in the accompanying drawings and the description below. Other features and advantages will be apparent from the description and drawings, and from the claims.

### DESCRIPTION OF DRAWINGS

FIG. 1 is a schematic diagram for an example system 100 that estimates, for example, TV ads displayed to TV viewers.

FIG. 2 is a block diagram of an example system 200 for generating ad impression estimates.

FIG. 3 is a flow chart of an example method 300 for generating ad impression estimates.

FIG. 4 is a schematic 400 that depicts an example method for merging cluster information according to one implementation.

FIG. 5 is a schematic of a general computing system, which can implement the described systems and methods according to one implementation.

Like reference symbols in the various drawings indicate like elements.

### DETAILED DESCRIPTION

This document describes systems, techniques and computer program products for estimating a number of times an advertisement is presented (e.g., displayed) to a viewer. In some implementations, a system can collect sample data from a selected group of television viewers. For example, the viewers may have set top boxes attached to their televisions that record what is watched. While reference is made to television, other forms of media distribution are possible. The systems, methods and computer program products proposed can be used to gather information about content (e.g., ads) that is presented to media receivers (e.g., viewers, listeners).

The sample data can be transmitted to the system and analyzed by associating the sample viewers with categories, or clusters that define a larger group to which the sampled viewers belong. For example, a cluster can be defined as all the television viewers in the Chicago area (of course the clusters can have a finer segmentation such as male, Chicago viewers that are 18-15, have a certain income, etc.). The system can use viewing habits of the sampled viewers that fall within the Chicago cluster to extrapolate (or otherwise derive) the viewing habits of the total population of the cluster (i.e., all the viewers in the Chicago area).

Specifically, the system can determine estimates associated with how many times a particular television ad is viewed by the population of the cluster. The system can use the estimates to bill advertisers based on how many times the advertisers' ads were displayed.

In some implementations, the system can merge the estimates of viewed ads from several clusters to determine an estimate for a larger viewing population. For example, a system can merge (e.g., as opposed to sum) estimates from a San Francisco cluster, a Berkeley cluster, a San Pablo cluster, a Emeryville cluster, and an El Cerrito cluster to determine estimated ad viewers for the Bay Area of California. In some implementations, the merging may enable a more holistic approach to ad viewing estimation when compared to summing up the individual estimates for each cluster. Various merging techniques are described in more detail below.

In some implementations, the sampled data is aggregated so that individually identifying information is anonymized while still maintaining the attributes or characteristics associated with a particular cluster. In other implementations, the sample data is anonymized (so that the originating set top box is unidentifiable) before transmission to the system that analyzes the sample data. In this way, the viewing habits of individual viewers can be obscured or unobservable while still permitting the determination of viewing habits for clusters or groups of viewers.

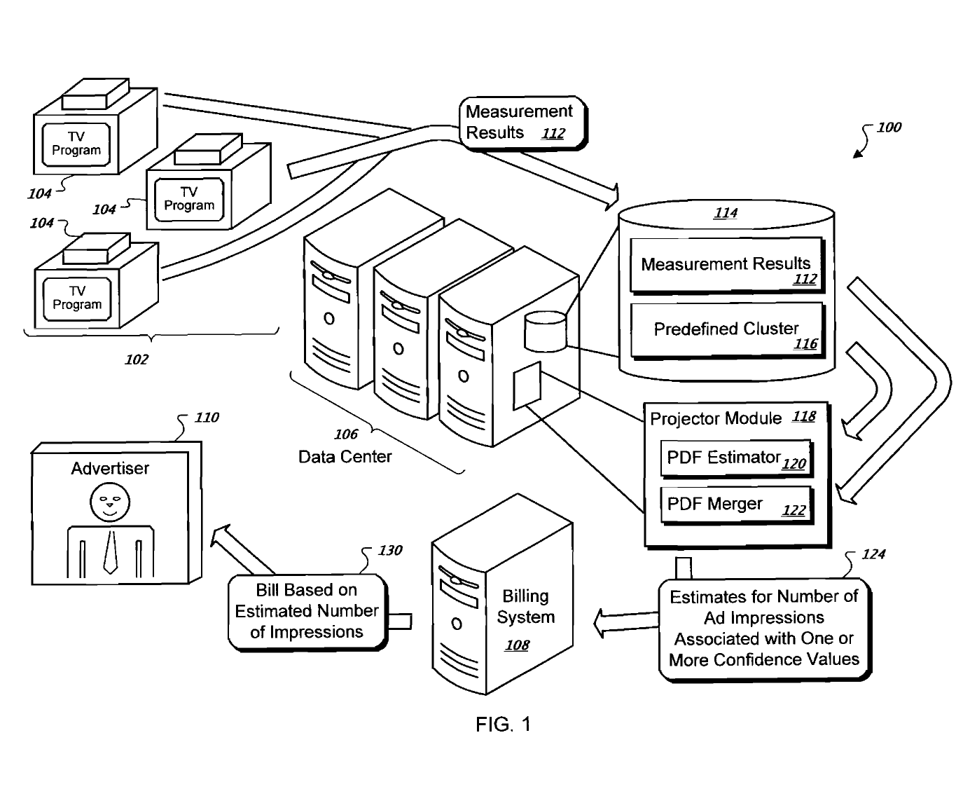

FIG. 1 is a schematic diagram for an example system 100 that estimates TV ads displayed to TV viewers. Ads displayed to viewers are also referred to as ad impressions. In the depicted implementation, the system 100 includes TVs 102 and set top boxes 104 that capture information from the TVs 102. The system 100 can include a data center 106 having one or more servers and a billing system 108.

The set top boxes 104 can transmit information to the data center 106, which uses the information to generate estimates about how many TV viewers have watched a particular advertisement. The data center 106 can forward the estimate of ad impressions to the billing system 108, which uses the estimate to bill advertisers, such as an advertiser 110, for an ad displayed to TV viewers. For example, the advertiser 110 may have agreed to pay $5 per ad impression. If the estimated number of ad impressions is 10, the billing system 108 can bill the advertiser for $50 ($50×10).

More specifically, the set top boxes 104 can transmit viewing information, or measurement results 112, from a sample of TV viewers. The measurement results 112 can include information used to derive how many particular viewers are in the sample set and which viewers have viewed a particular ad (where viewing an ad and having an ad display to a TV viewer are treated as synonymous). Additionally, the measurement results 112 can include (or can be used to derive) demographic information about the viewers such as geographical location and household size (which refers to the number of televisions within a household, such as 1, 2, 3, 4 or more TVs for a single household).

In some implementations, the set top boxes 104 interface with the TVs 102 to record what is currently playing. The results or a summary of the results are transmitted by the set top box 104 using, for example, a telephone connection to the data center 146 (where the connection can be direct or through a network such as the Internet).

The data center 106 can store the measurement results 112 in a database 114. The database 114 also can include other information such as predefined cluster information 116. In some implementations, the predefined cluster information can include clusters (also referred to here as groups or classifications) such as designated market areas (DMA). For example, a DMA can include a geographic location such as Chicago. The clusters can also be segmented based on other information such as household size information. The cluster information 116 can include a total number of TV viewers associated with each cluster. For example, one predefined cluster may be a cluster having the DMA equal to Chicago in the household size equal to 3 and a total TV viewership of 980,000. Clusters can be used to divide, or segment, an area such as the United States into groups that can be analyzed.

The data center 106 can also include a projection module 118 hosted a on a server. The projection module can use the measurement results 112 and the predefined clusters 116 to generate, or project, estimates about how many viewers in one or more clusters are viewing a particular advertisement.

More specifically the projection module can include a probable density function (PDF) estimator 120 and a PDF merger 122 that generate estimates for a number of ads viewed by people associated with one or more clusters. For a given cluster, the PDF estimator 122 can estimate a probability distribution associated with estimated ad impressions (e.g., the probabilities associated with a range of possible estimates for ad impressions). For example, assume that a first cluster is for the Chicago area. The PDF estimator 120 can use the measurement results 112 for Chicago and the predefined cluster information 116 for Chicago to estimate that there is a 0.5 probability that 20,000 viewers within Chicago watched an ad, a 0.3 probability that 30,000 viewers within Chicago watch the ad, and a 0.2 probability that 50,000 viewers within Chicago watch the ad. These three estimates represent the probability distribution for the ad impressions. An example calculation process is described in more detail below.

In some implementations, the PDF merger can merge the probabilities generated for one or more clusters to produce a holistic look at the probability distribution. For instance, the PDF merger can generate a single estimate of ad impressions for several clusters based on characteristics of several clusters instead of generating ad impression estimates for each of the clusters and then summing the estimates together for a total estimate.

For example, given the following three clusters and the associated measurement information
CHICAGO: 14 viewers out of 28 possible viewers in sample: 555 total potential viewers
NYC: 25 viewers out of 55 possible viewers in sample: 634 total potential viewers
LA: 33 viewers out of 54 possible viewers in sample: 45992 total potential viewers
   one approach would be to determine an ad impression estimate for each cluster that satisfies a probability threshold (also referred to as a confidence value). For example, assuming a confidence value is 0.9, then an ad impression estimate can be selected from the probability distribution that satisfies this value. The PDF merger could sum the ad impression estimates corresponding to the confidence values to generate a total impression estimate number.

In a second more holistic approach mentioned above, the PDF merger uses the characteristics directly to determine an ad impression estimate that satisfies a given confidence value. In this case, the PDF merger does not treat ad impression estimates for each cluster as independent, but instead the PDF merger constructs an overall most-likely estimate of ad impressions. An example merging calculation for this second approach is discussed in more detail below.

The output 124 of the projection module 118 can include one or more estimates for a number of ad impressions, where each estimate is associated with one or more confidence values previously mentioned above. For example, a user can specify that the projection module 118 should output estimates that correspond to confidence values 90%, 50%, and 25%. A confidence value of 90% (i.e., 0.9) can indicate that the actual number of ad impressions will be equal to or lower than the estimated number of ad impressions 9 out of 10 times. Conversely, a confidence value of 90% indicates that the actual number of ad impressions will likely be higher than the estimated number of ad impressions 1 out of every 10 times.

In some implementations, one or more of the ad impression estimates is transmitted to the billing system 108. For example, the estimate associated with a 90% confidence value can be transmitted to the billing system 108. The billing system 108 can use the estimated number of ad impressions to bill an advertiser that is responsible for the ad displayed to the television viewers. For example, the advertiser 110 may have agreed to pay $10 per 1,000 impressions. If the estimated number at a 90% confidence value is 70,000 impressions, the billing system 108 can calculate a bill 130 of $700 ($10×(70,000/1,000)) for displaying the ad. In one implementation, the billing system 108 can transmit the bill 130 to the advertiser 110 for payment. In another implementation, a billing system 108 can withdraw the billed amount automatically from a financial institution based on prior authorization by the advertiser 110.

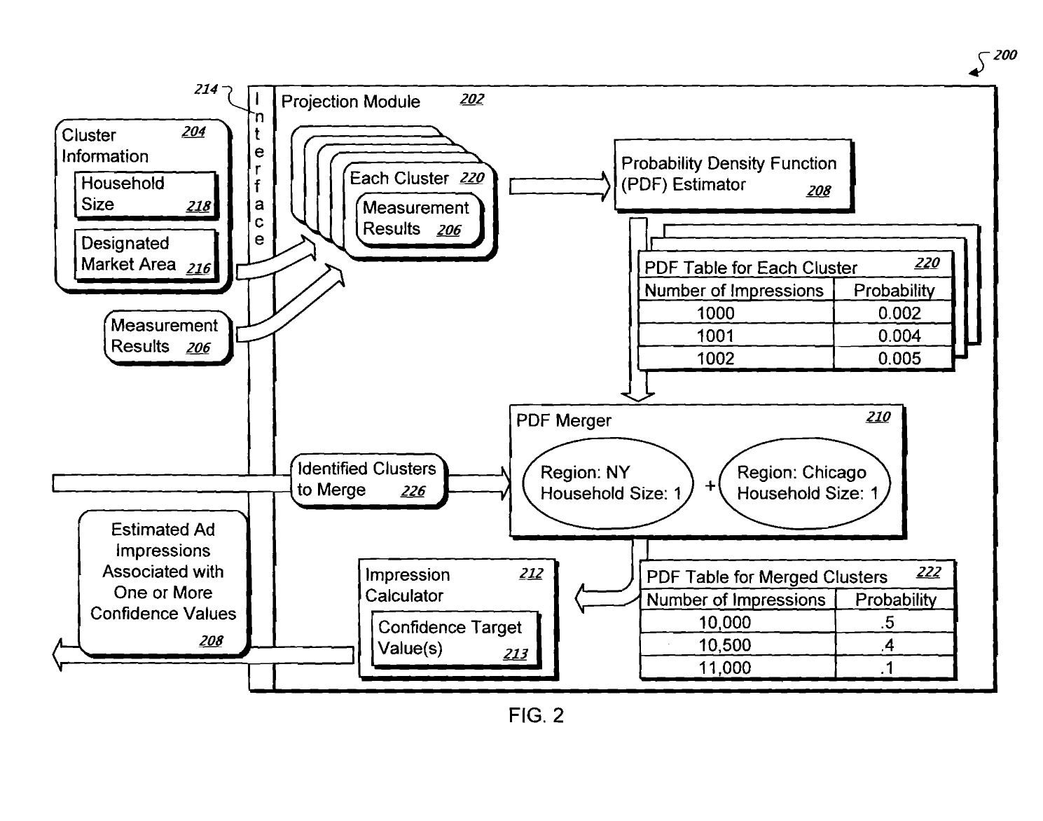

FIG. 2 is a block diagram of an example system 200 for generating ad impression estimates. The system 200 includes a projection module 202 that accepts cluster information 204 and measurement results 206 and outputs estimates 208 of ad impressions associated with one or more confidence values. In the example system 200, the projection module 202 includes a PDF estimator 208, a PDF merger 210, and an impression calculator 212.

The projection module 202 can receive the cluster information 204 and the measurement results 206 through an interface 214. A database (not shown) can transmit the cluster information 204 to the projection module 202. A third party may transmit the cluster information 204 for storage in the database before the transmission of the information to the projection module 202. For example, the cluster information can include DMAs 216 that are defined by the Nielsen Company. A DMA can include information about a region where the population receives similar TV offerings. The cluster information 204 can also include information used to further segment a DMA such as household size 218, age groups, genders, ethnic backgrounds, income levels, other demographic data, etc.

In one implementation, the projection module 202 uses the cluster information to generate clusters, or groups, of viewers that have distinct characteristics. For example, a Chicago male cluster can contain viewers from the Chicago area, that have a household size of two, an income level of over $100,000, a gender of male, and age range between 18 and 45. In another implementation, the clusters are predefined before transmission to the projection module 202 from the database.

The measurement results 206 include measured information gathered from TV viewers within a sample. In some implementations, each of the TV viewers can fall within one of the clusters described above, which is indicated in FIG. 2 by the placement of the measurement result 206 within a particular cluster 220. For example, 2,400 sample viewers may fall within the Chicago male cluster described in the previous paragraph. The measurement results 206 can indicate what sampled TV viewers watched including which ads were displayed to the viewers.

The PDF estimator 208 can use a probability density function to determine probabilities associated with various ad impression estimates for a particular cluster of viewers. The PDF estimator can use the measurement results 206 obtained from sample viewers associated with the cluster to derive these estimates.

For example, measurement results 206 may indicate that 260 of a possible 580 sampled TV viewers associated with a particular cluster were shown a particular ad (e.g., 260 were watching a network that displayed the ads and 320 were watching a network that did not display the ads). In some implementations, the PDF estimator 208 can use Bayesian statistical analysis to derive ad impression estimates for all viewers within the particular cluster using the measurement results 246 gathered from the sample viewers. For example, the PDF estimator 208 can generate a PDF table 220 that includes a range of estimates for the number of ad impressions and a probability of associated with each estimate indicating the likelihood that the estimate is correct.

In the exemplary table 220, for a particular cluster, three estimates for ad impressions are given: 1000, 1001, and 1002. The probability is 0.002 that the actual number of ad impressions for the total viewership of the cluster matches the estimate 1000. Similarly, the likelihood that the estimate 1001 is correct is 0.004, and the likelihood that the estimate 1002 is correct is 0.005. In this example, the likelihood that the actual number of ad impressions is at or below the estimate of 1002 is the sum of the probabilities associated with the estimates 1002 and below. For example, the probability that the actual number of ad impressions is 1002 or below is the sum 0.009 (0.005+0.004+0.002).

In some implementations, the projection module's probability density function is derived using Bayesian inference given hypergeometric distribution as a likelihood function and given uninformed distribution of prior probability (e.g., uniform distribution). In some implementations, the hypergeometric distribution described at http://en.wikipedia.org/wiki/Hypergeometric_distribution (visited Nov. 16, 2007 and incorporated here) is used. In some implementations, the likelihood function described at http://en.wikipedia.org/wiki/Likelihood_function (visited Nov. 16, 2007 incorporated here) is used.

Additionally, in some implementations, the PDF estimator 208 uses the following probability function

$$P ( M \vert n , m , N ) = ( \begin{matrix}N - n \\ M - m\end{matrix} ) \frac{M !}{m !} \frac{( N - M ) !}{( n - m ) !} \frac{( n + 1 ) !}{( N + 1 ) !}$$

to determine the probability associated with each ad impression estimate in a single cluster (where M denotes the estimate for the total number of impressions, n the sample size, m number of impressions in the sample and N the size of the total population).

In some implementations, instead of sampling the whole range of possible values for M, the lower and upper bounds for the total number of impressions can be estimated by requiring that between those values the probability density function is large enough. In some implementations, the lower and upper bounds for the total number of impressions (x_{low},xᵤₚₚ) can be found by solving the following equations in x_{low},xᵤₚₚ

(x_{low}−mₗₒ)P(x_{low})=ε

(N−n+m−xᵤₚₚ)P(xᵤₚₚ)=ε

where ε is a fixed error bound that determines the precision with which the requested confidence should be met. The lower the required precision, the lower the computable width of the probability distribution (xᵤₚₚ−x_{low}), and the less computations required, which in turn increases performance. In some implementations, a constraint can be set so that ε=10⁻⁴, which results in the confidence being met with 0.01% precision.

In some implementations, the projection module 202 uses a logarithmic scale in dealing with combinatorial quantities. For example, the following pseudo code can be used, where LogGamma( ) is a natural logarithm of a Gamma function (and, for all positive integer n, Gamma(n+1)=n!) and LogChoose( ) is a logarithm of a binomial coefficient.

```
LogProjectorPDF =
  LogChoose(total_size − sample_size,
      total_impressions − sample_impressions) +
  LogGamma(total_impressions + 1) −
  LogGamma(sample_impressions + 1) +
  LogGamma(total_size − total_impressions + 1) −
  LogGamma(sample_size − sample_impressions + 1) +
  LogGamma(sample_size + 2) −
  LogGamma(total_size + 2);
```

In some implementations, the PDF merger 210 can merge information associated with two or more clusters to produce a single merged PDF table 222 for the merged clusters. For instance, the PDF merger 210 can merge two or more of the PDF tables generated for each cluster to produce the merged PDF table 222. For example, the PDF merger can merge PDF tables for a New York cluster and a Chicago cluster as depicted in FIG. 2.

In some implementations, viewers within one cluster are assumed to be independent from viewers in a different cluster for statistical purposes. Furthermore, in some implementations, viewers within a single cluster as also assumed to be independent of other viewers within the same cluster. Given these assumptions, the PDF merger 210 uses the following formula to merge L PDF tables

$${p}_{merged} ( x ) = {\sum }_{{x}_{1} + {x}_{2} + … + {x}_{L} = x} {p}_{1} ( {x}_{1} ) {p}_{2} ( {x}_{2} ) … {p}_{L} ( {x}_{L} )$$

In some implementations PDF merger 210 may use a Fast Fourier Transform algorithm to perform a merge of L PDF tables

P_{merged}=F⁻¹[F[p₁]F[p₂] . . . F[p_{L}]]

where F denotes a forward Fourier transform and F⁻¹ its inverse.

According to some implementations, the PDF merger 210 only merges a subset of the total set of clusters. For example, the PDF merger 210 can access information 226 to identify particular clusters to merge. In some implementations, the identifying information 226 can be generated based on an advertiser's selection of advertising campaign parameters such as a geographical area to show an ad, a broadcasting network on which to display the ad, demographic information for viewers, etc.

For example, an advertiser can specify that an ad should run nationally on the ESPN broadcasting network. The advertiser's specification can be used to identify clusters that are associated with the ESPN broadcasting network, and more specifically, clusters associated with the ESPN broadcasting network that are located in several geographical areas (e.g., Chicago, New York, San Francisco, Los Angeles, etc.) that together make up a national market. The PDF merger 210 can then use the identifying information 226 to identify the appropriate clusters to merge.

As previously mentioned, the merged PDF table 222 can include a range of estimated ad impressions and corresponding probabilities of occurrence for each estimate. For example, the merged PDF table 222 includes three estimates and three corresponding probabilities for each estimate. The estimates are 10,000 having a probability of 0.5; 10,500 having a probability of 0.4; and 11,000 having a probability of 0.1.

In some implementations, the impression calculator 212 can select one or more of the ad impression estimates based on confidence target values 213. For example, an estimate can be selected based on a confidence value of 0.90, and the estimate can be transmitted to a billing system for use in billing an advertiser.

In some implementations, the impression calculator can determine the ad impression estimate that is associated with a confidence value by summing the probabilities of estimates (starting with probabilities associated with the lowest estimate and summing the next lowest estimate, and so forth) until the sum of the probabilities are substantially equal to the desired confidence value.

For example, if the confidence value is 0.90, the impression calculator 212 can sum the probability 0.5 (associated with the lowest ad impression estimate) with the probability 0.4 (associate with the next lowest ad impression estimate) for a total of 0.9. Because the summed total (e.g., 0.9) equals the desired confidence probability 0.9, the impression calculator can select the ad impression estimate associated with the last summed probability, which in this example is 10,500. Practically, selection of the ad impression estimate 10,500 indicates that there is 90% chance (i.e., 0.9 chance) that the actual number of ad impression is equal to or less than the selected ad impression estimate.

In some implementations, the impression calculator 212 specifies more than one confidence value. Consequently, more than one corresponding ad impression estimate is identified by the impression calculator 212. The projection module 202 can transmit one or more of the calculated ad impression estimates 208 corresponding to the confidence target values 213 to another system for further processing (e.g., a billing system for use in calculation of an amount to charge an advertiser for display of the ad).

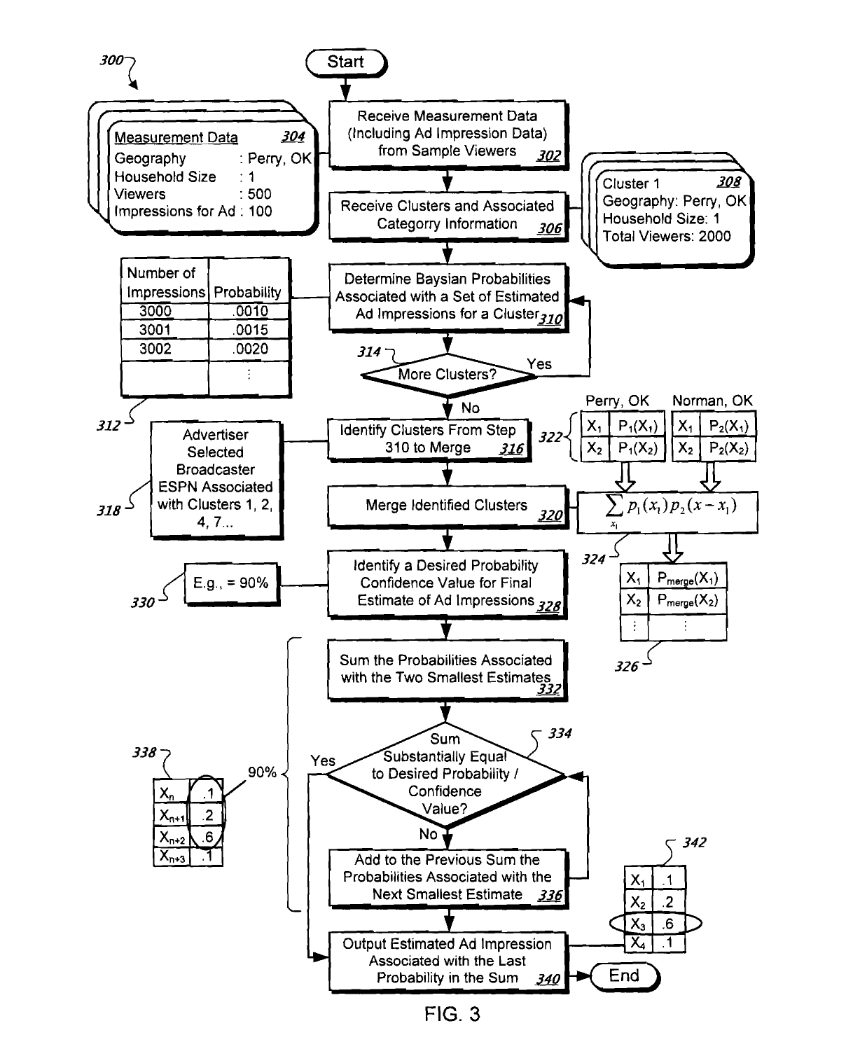

FIG. 3 is a flow chart of an example method 300 for generating ad impression estimates. The method 300 may be performed, for example, by a system such as the systems 100 and 200; however, another system, or combination of systems, may be used to perform the method 300.

The method 300 begins with step 302, where measurement data (including sampled ad impression data) is received from sampled TV viewers. For example, measurement data 304 can include information from sampled TV viewers such the depicted geographic indicator “Perry, OK”; Household size: “1”; Total Sampled Viewers “500” for a group matching the geography and household size characteristics; and an indication of how many of the total sampled viewers watched the ad, which in this case is “100.”

In step 306, cluster and associated category information is received. For example, clusters can be generated using the cluster and associated category information. A database can store pre-segmented groups, or clusters, such as the DMA groups. In some implementations, the clusters can be further segmented based on information such as demographic information and household size as indicated by a cluster 308. The cluster 308 indicates that 2,000 possible viewers having a household size of “1” are associated with the geographic area Perry, Okla.

In step 310—for a selected cluster—probabilities (e.g., Bayesian) associated with a set of estimated ad impressions are determined. For example, the PDF estimator 208 can generate a PDF table 312, which includes ad impression estimates and probabilities associated with those estimates.

In step 314, it is determined if some clusters have not been processed. If there are additional clusters for which probabilities have not been calculated, step 310 is repeated. If there are no more additional clusters to process, step 316 is performed.

In step 316, probabilities calculated for clusters in step 310 are identified for merging. For example, an advertiser can select campaign parameters that are associated with particular clusters as indicated by the information 318. These particular clusters are identified for merging.

In step 320, the identified clusters are merged. For example, two PDF tables 312 associated with clusters for the geographic regions Perry, OK and Norman, OK can be merged using a formula 324. The output is the merged table 326 that includes ad impression estimates and associated probabilities derived from the PDF tables 312.

In step 328, a desired confidence value for a final estimate of ad impressions is identified. For example, the ad impression calculator 312 can specify that a desired confidence value 330 is 90%. In some implementations, this value is previously set by a user or software developer of the projection module 202.

In step 332, the probabilities associated with the two least ad impression estimates are summed. In step 334, it is determined whether the sum substantially equals the desired confidence value. If the sum is not substantially equal, step 336 is performed. In step 336, the previous sum is added to the probability associated with the next lowest ad impression estimate and the determination of step 334 is repeated.

For example, the probabilities associated with the ad impression estimates Xₙ−Xₙ₊₃ are summed starting with the probabilities (0.1 and 0.2) associated with the lowest ad impression estimates (e.g., Xₙ and Xₙ₊₁). Because the sum 0.3 (i.e., 0.1+0.2) is less than the desired confidence value of 0.9, step 336 is repeated and the next probability 0.6 associated with the next lowest ad impression estimate Xₙ₊₂ is added to the previous sum of 0.3. This brings the new total to 0.9, which is equal to the desired confidence value. If it is determined in step 334 that the sum is substantially equal to the desired confidence value, step 340 is performed.

In step 340, the estimated ad impression associated with the last probability added to the sum is output. For example, the estimated ad impression Xₙ₊₂ would be output because the sum of probabilities for the Xₙ₊₂ and lower estimates is equal to 0.9, which is the desired confidence value. This is indicated by the circled values in the PDF table 342. After step 340, the method 300 can end.

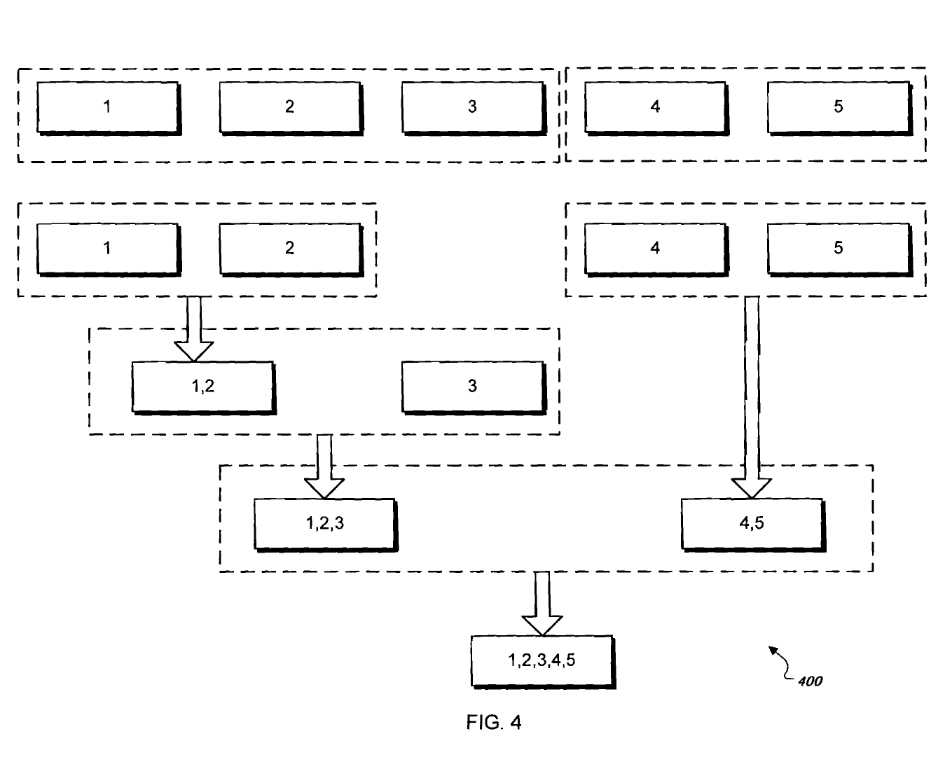

FIG. 4 is a schematic 400 that depicts an example method for merging cluster information according to one implementation. In some implementations an N-way merge includes the following two properties. First, an N-way merge via a Fast Fourier Transform (FFT) algorithm described above requires O(N) memory and O(N log(N)) time. Second, an N-way merge can result in loss of precision.

The first property indicates that an FFT algorithm cannot directly merge a large number of PDFs at once. Thus, a multi-stage merge can be used to mitigate consequences the first property. For example, in some implementations, a multi-stage merge forms a merge tree using N-way FFT based merge as a building block.

In some implementations a balanced height merge can reduce the number of times an original PDF participates in a FFT, thus mitigating the effect of the second property. In this example, a balanced height merge means that for every node all sub trees have the same height (±1) as indicated in FIG. 4.

More specifically, FIG. 4 shows a 2-way balanced merge for 5 PDFs. The balance merge algorithm runs as follows. In step one, the input to the merge algorithm is split evenly in two bins (1,2,3 goes to the first bin and 4,5 to the second bin). In step two, since the first bin has more than two items, it is split again evenly into two bins (1,2 goes to the first bin, 3 goes into the second bin) . In step three, the input 1 and 2 are merged into the result “1,2”. In step four, the inputs “1,2” and 3 are merged into the result “1,2,3”)

In step five, returning to the second bin of step one, inputs 4 and 5 are merged into the result “4,5”. In step six, the inputs “1,2,3” and “4,5” are merged into the result “1,2,3,4,5”. In step seven, the final result “1,2,3,4,5” is output.

In some implementations, a 4-way merge may perform better than either 2,3 or 5,6 and 7 way merges with a number of sampling points fixed to be 3125 (5⁵).

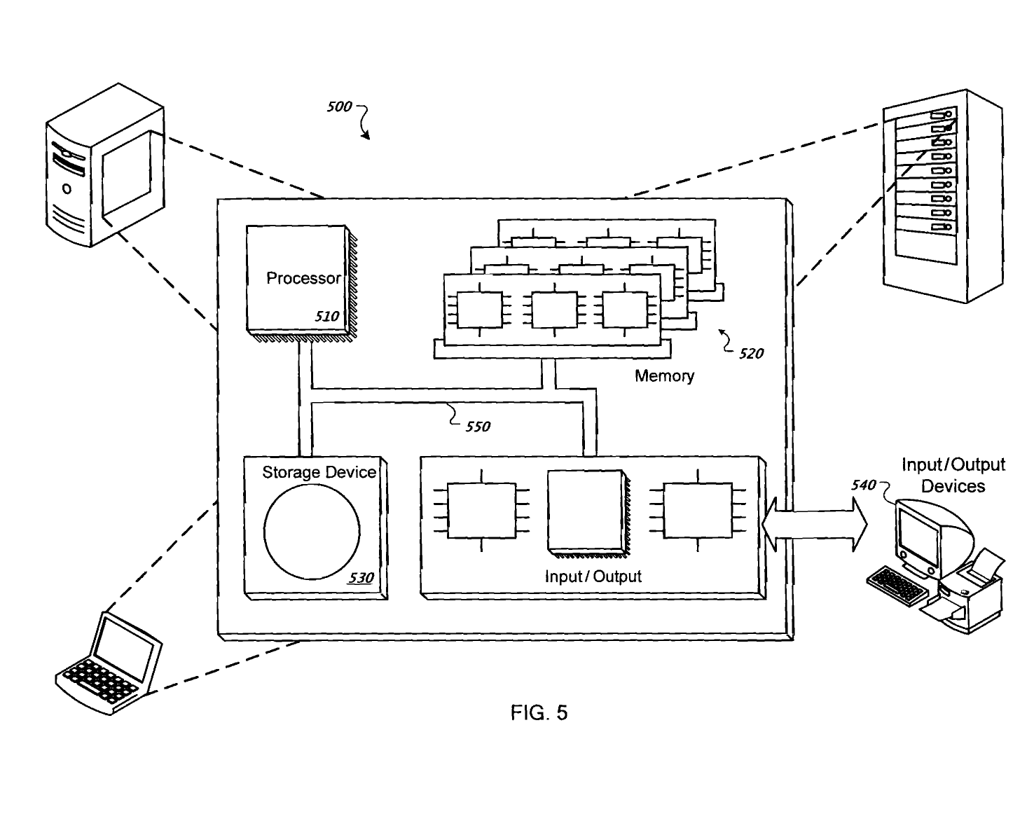

FIG. 5 is a schematic diagram of a computer system 500. The system 500 can be used for the operations described in association with any of the computer-implement methods described previously, according to one implementation. The system 500 is intended to include various forms of digital computers, such as laptops, desktops, workstations, personal digital assistants, servers, blade servers, mainframes, and other appropriate computers. The system 500 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, although described in the context of estimating a number of TV viewers, other implementations may be used to estimate a number of other types of media receivers. For example, some implementations may estimate a number of radio listeners, a number of viewers watching ads embedded in video (e.g., YOUTUBE videos), a number of readers of print ads, etc.

Additionally, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving cluster information comprising categories and total numbers of media receivers associated with the categories;
receiving sample data comprising numbers of advertisements (ads) displayed to sampled media receivers that are classified within the categories;
calculating probabilities for numbers of ads displayed to the total numbers of media receivers associated with the categories, wherein the calculation is based on the cluster information and the sample data;
merging the calculated probabilities associated with two or more of the categories; and
outputting an estimated number of ads displayed based on the merged probabilities.

2. The method of claim 1, wherein the media receivers comprise television (TV) viewers or radio listeners.

3. The method of claim 1, further comprising identifying the estimated number of ads displayed based on a confidence that the actual value is substantially equal to or less than the estimated number.

4. The method of claim 3, wherein the confidence is specified by a confidence value that expresses a probability.

5. The method of claim 4, further comprising receiving multiple confidence values that are used to identify multiple estimates for the number of ads displayed.

6. The method of claim 1, wherein merging the calculated probabilities comprises generating multiple estimates for the number of ads displayed and determining associated probabilities that express a likelihood of occurrence for each of the estimates.

7. The method of claim 1, wherein calculating the probabilities for the number of ads displayed comprises applying a probability density function (PDF) to determine a probability associated with each ad impression estimate in a category.

8. The method of claim 7, wherein the PDF comprises the formula
$$P ( M \vert n , m , N ) = ( \begin{matrix}N - n \\ M - m\end{matrix} ) \frac{M !}{m !} \frac{( N - M ) !}{( n - m ) !} \frac{( n + 1 ) !}{( N + 1 ) !}$$
where M denotes the estimate for the total number of impressions, n the sample size, m number of impressions in the sample and N the size of the total population.

9. The method of claim 8, wherein the upper and lower bounds for a total number of ad impressions associated with the category is determined based on a solution to the following equations:
(x_{low}−m)P(x_{low})=ε
(N−n+m−xᵤₚₚ)P(xᵤₚₚ)=ε
where ε is a specified fixed error bound that determines a precision with which a requested confidence should be met, x_{low} is the lower bound, and xᵤₚₚ is the upper bound.

10. The method of claim 7, wherein the PDF is derived using Bayesian inference.

11. The method of claim 10, wherein the Bayesian inference takes into account a hypergeometric distribution as a likelihood function.

12. The method of claim 10, wherein the Bayesian inference takes into account a uniform distribution of prior probability.

13. The method of claim 1, wherein the merging is based on a balanced tree merge with a Fast Fourier Transform (FFT) based merge as an atomic operation.

14. The method of claim 13, wherein the FFT based merge is based on the following formula:
P_{merged}=F⁻¹[F[p₁]F[p₂] . . . F[p_{L}]]
where F denotes a forward Fourier transform and F⁻¹ an inverse Fourier transform.

15. The method of claim 1, wherein the categories comprise designated market areas, household size, or a combination thereof.

16. The method of claim 1, wherein the sample data is received from a computing device associated with TVs of the sampled media receivers.

17. The method of claim 1, further comprising calculating a bill for an advertiser based on the estimated number of ads displayed.

18. The method of claim 1, wherein the merging is based on the following formula:
$${p}_{merged} ( x ) = {\sum }_{{x}_{1} + {x}_{2} + … + {x}_{L} = x} {p}_{1} ( {x}_{1} ) {p}_{2} ( {x}_{2} ) … {p}_{L} ( {x}_{L} ) .$$

19. The method of claim 1, wherein calculating probabilities for numbers of ads displayed comprises using a logarithmic scale when calculating with combinatorial quantities.

20. A computer-implemented method comprising:
receiving, from a sample of media receivers, measurement data comprising information associated with one or more advertisements (ads) presented to the media receivers;
associating the sample of media receivers with one or more clusters, each cluster having geographic attributes and a total number of media receivers within the cluster;
determining multiple ad viewing estimates for a number of times an ad was viewed by the total number of media receivers of the cluster, wherein the ad viewing estimates are associated with probabilities of occurrence;
merging the probabilities associated with two or more clusters; and
outputting an estimated number of ads displayed for the one or more clusters based on the merged probabilities.

21. A system comprising:
an interface to receive measurement data comprising numbers of advertisements (ads) displayed to sampled media receivers and cluster information comprising groupings defined by commonly shared attributes of TV media receivers and a total number of media receivers associated within each grouping;
means for calculating probabilities for a number of ads displayed to the total number of media receivers for each cluster, wherein the calculation is based on the cluster information and the measurement data; and
means for merging the calculated probabilities associated with the clusters and outputting an estimated number of ads displayed for the one or more clusters based on the merged probabilities.
